(19) United States
(12) Patent Application Publication
(10) Pub. No.: US 2005/0192379 A1
(43) Pub. Date: Sep. 1, 2005

(54) Eradicable composition and kit

(76) Inventor: Wing Sum Vincent Kwan, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/113,671

(22) Filed: Apr. 25, 2005

Related U.S. Application Data
(63) Continuation-in-part of application No. 10/619,706, filed on Jul. 15, 2003, now Pat. No. 6,905,539.

(51) Int. Cl. C09D 11/00; C03C 17/00

(52) U.S. Cl. 523/160; 106/31.27; 106/31.39; 106/31.38; 106/31.37; 523/161

(57) ABSTRACT

An aqueous shear-thinning eradicable marking composition such as an ink, including water, a dye selected from the group consisting of diarylmethane derivatives, triarylmethane derivatives, methine dyes, and a film-forming resin, wherein the composition has a shear-thinning index in the range of about 0.35 to about 1.0; a kit including the composition and an eradicator solution; a complex including a colorless or substantially colorless dye selected from the group consisting of oxidized diarylmethane derivatives, oxidized triarylmethane derivatives, and oxidized methine dyes, and a film-forming resin; and methods of using the composition as part of an eradicable ink system, are disclosed herein.

### CROSS-REFERENCE TO RELATED APPLICATION

This is a continuation-in-part of U.S. patent application Ser. No. 10/619,706 filed Jul. 15, 2003, now U.S. Pat. No. ______.

### BACKGROUND

1. Field of the Invention

The invention relates generally to aqueous compositions that are capable of chemical eradication. More particularly, the invention relates to marking composition that includes an eradicable dye and a film-forming resin.

2. Brief Description of Related Technology

Eradicable ink systems generally include two components. One component is an aqueous ink that includes a dye—typically a triarylmethane—that can be rendered substantially colorless when contacted with a substance such as a sulfite oxidizing agent or an amine. The second component is an aqueous eradicator fluid that includes a substance that can cause the dye to convert to a substantially colorless form. A user writes with the ink and, if correction is necessary, applies the eradicator fluid to the ink marking to decolorize the dye.

Prior aqueous inks used in eradicable ink systems have the disadvantage that they tend to leave a permanent mark when applied to fabrics such as clothes. In addition, aqueous ink instruments (e.g., pens and markers) used in an eradicable ink system can be prone to leakage and drying out.

Traditional non-gel inks that are used in ball-point pens typically include largely non-volatile organic solvents, such as benzyl alcohol, phenyl cellosolve, diethylene glycol monoethyl ether, dipropylene glycol, glycerin, and propylene glycol. Non-gelled ball-point pen inks tend to have a relatively high viscosity (e.g., greater than 10,000 centipose (cP)).

Triarylmethane dyes generally include a relatively hydrophilic counter-ion that renders the dye insoluble in non-volatile organic solvents (e.g., Acid Blue 93 includes two sodium counter-ions). Thus, one of the problems associated with using an eradicable dye (e.g., a triarylmethane dye) in a typical ball-point ink formulation is the low solubility of triarylmethane dyes in the non-volatile organic solvents that are used in typical non-gelled ball-point ink systems.

### SUMMARY

One aspect of the disclosure is an aqueous marking composition including a dye selected from the group consisting of diarylmethane derivatives, triarylmethane derivatives, methine dyes, and combinations of thereof, a slow-evaporating solvent, and a film-forming resin.

Another aspect of the disclosure is a method of eradication, the method including the step of applying an eradicator solution to a dried marking composition disclosed herein.

Yet another aspect of the disclosure is a kit including a marking composition described herein and an eradicator.

Yet another aspect of the disclosure is a complex including a colorless or at least substantially colorless dye selected from the group consisting of oxidized diarylmethane derivatives, oxidized triarylmethane derivatives, oxidized methine dyes, and combinations thereof, and a film-forming resin.

Further aspects and advantages of the disclosed compositions, kits, and methods may become apparent to those skilled in the art from a review of the following detailed description, taken in conjunction with the appended claims. While the compositions, kits, and methods are susceptible of embodiments in various forms, the description hereinafter includes specific embodiments with the understanding that the disclosure is illustrative.

### DETAILED DESCRIPTION

Eradicable marking compositions are described herein. A major use for such compositions is in inks, for example ballpoint pen inks. Accordingly, the compositions are often referred to as inks herein, but is to be understood that the compositions are not limited to inks and can be used in any application and preferably as marking compositions, more preferably as inks.

The process of ink marking and eradication proceeds in two steps: the first is the marking of a substrate (e.g., paper) with an eradicable ink, and the second is the application of an eradication solution to the marking. A typical formulation for an eradicable ink includes a solvent (e.g., water) to dissolve a dye that is capable of such being eradicated (e.g., a triarylmethane dye), and typical eradicable ink formulations include organic solvents having low surface tension. The eradication solution includes an eradicator that, by a chemical process, converts an otherwise colored dye into a substantially colorless compound or a color that matches that of the substrate (e.g., white for white paper). Such compounds include oxidizing agents, reducing agents, acid-base reactants, and chemicals that can sublime under the influence of heat. Without intending to be limited to any particular method of eradication, it is believed that for triarylmethane dyes, the active colored dye is able to reflect color in the visible wavelength range (approximately between 380 nm to 780 nm) because of the conjugation of the aromatic rings in the molecule; however, once an oxidizing agent is applied to the triarylmethane dye, it destroys the conjugation and the dye becomes at least substantially colorless. This proposed process is shown below for Acid Violet 17:

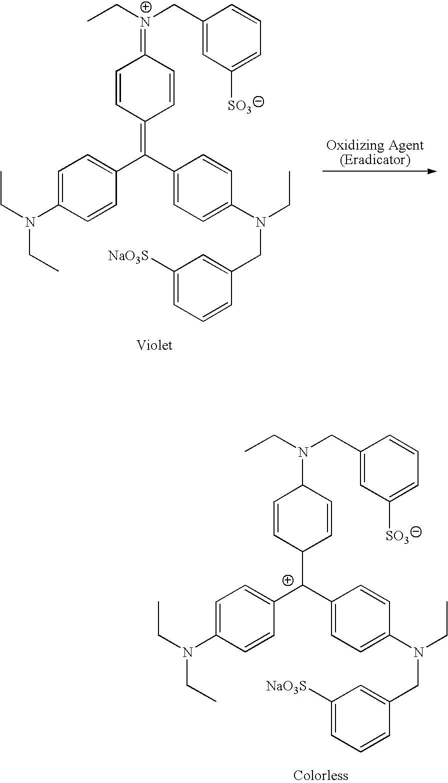

The eradication solution preferably includes water or an organic solvent as the primary solvent, an eradicator such as, for example, a sulfite, bisulfite, or an amine (e.g., sodium glycinate) that can cause certain dyes to lose their colors (e.g., triarylmethane dyes) or to change color, and a film-forming polymer. A suitable eradicator solution for the inks disclosed herein is a commercially available eradicator solution that includes both a sulfite and an amine as active eradicating agents (e.g., oxidizers) (available from Sanford Reynolds of Valence, France).

A gel ink system, embodiments of which are also described herein, is a shear-thinning ink, the viscosity of which is altered at the site of application of a shear force to the ink. As the viscosity of the ink is lowered upon the application of force, the properties of the ink change from a static gel state to a more fluid state, that is, more capable of movement.

One advantage of this reduction in viscosity upon the application of shear force is the ability to convert a gel ink that is too viscous to be capable of marking a substrate (e.g., paper) into an ink that has a viscosity low enough to mark a substrate. For example, a gel ink present in a ball-point pen is acted upon by a ball present at the writing tip of the pen. The rolling of the ball exerts a shear force on the gel ink in the vicinity of the ball, and the resulting reduction in viscosity of the ink causes the ink to flow from its high viscosity gel state to a lower viscosity and thereby to flow out of the pen. Another advantage of formulating an eradicable ink as a gel ink is that a gel ink is less prone to drying upon being exposed to the atmosphere.

The response that a fluid has in response to stress falls into two categories, those that exhibit Newtonian behavior (a Newtonian fluid) and those that exhibit non-Newtonian behavior (a non-Newtonian fluid). A Newtonian fluid is a fluid whose shear stresses are a linear function of the fluid shear rate. The best-known Newtonian fluid is water. The flow behavior of Newtonian fluids is simple to describe, as they follow Newton's law of viscosity given by equation Newton's law of viscosity is given by the equations τ=μ(dv/dy), wherein τ is shear stress, μ is the viscosity of fluid, and dv/dy is the shear rate (also known as the velocity gradient).

Preferred ink compositions disclosed herein are aqueous, polymeric, and shear-thinning. The ink compositions are thickened liquids at rest and are non-Newtonian liquids that may have a Theological yield value and exhibit shear-thinning flow behavior or shear-thinning flow characteristics in use. Typically, they become thin, readily flowable liquids having a viscosity of about 100 cP or less at shear rates produced in writing such as, for example, with a ball-point pen. The ink compositions include at least one water dispersible, polymeric gelling agent or thickener uniformly dispersed in a carrier which is primarily water.

Quite surprisingly, it has been found that formulating an eradicable ink system including a dye such as a triarylmethane dye into formulation with shear-thinning properties (e.g., a gel or thickened formulation) avoids problems associated with a non-gelled aqueous eradicable ink system (e.g., excessive drying of the ink).

Non-Newtonian liquids are liquids that do not obey Newton's law of viscosity and, thus, the viscosity no longer holds as a constant value but depends on the magnitude of the applied shear rate. Hence, the viscosity of the fluid varies as a function of the shear rate applied to the fluid. The Cross model, shown below in formula (I), can be used to describe the behavior of a non-Newtonian fluid over a broad range of shear rates:

$$\frac{η - {η}_{∞}}{{η}_{0} - {η}_{∞}} = \frac{1}{( 1 + {( {K}_{1} \dot{γ} )}^{{n}_{1}} )} \qquad ( I )$$

wherein η₀ and η_{∞} are the Newtonian viscosities at low and high shear rate plateaus, respectively, K₁ is a constant with the dimension [s], and n₁ is a dimensionless constant. By solving this equation, the Cross shear-thinning index (n_{cross}) can be determined for a given non-Newtonian liquid.

While the Cross model describes the behavior of fluids across a wide range of shear rates, an alternative to the Cross model, the Power law equation (τ=Kγⁿ), can also be used to describe the behavior a fluid. The Power law equation describes the behavior of fluid over a narrower range than the Cross model, but the Power law model will generally suffice to describe the behavior of most non-Newtonian liquids. The Power law equation allows for the calculation of the Power law shear-thinning index (n_{power}) by fitting shear stress (τ) and shear rate values (γ) obtained from rheological measurements on a viscometer such as a CARRI-MED rheometer (CSL² 500), TA Instruments, New Castle, Del. (K and n are calculated constants). For the ink disclosed herein, either the Cross shear-thinning index (n_{cross}) or the Power law shear-thinning index (n_{power}) can be used to determine the behavior of an ink. The measurement of the shear-thinning index (n) of the ink disclosed herein is obtained by measurements of an aqueous solution of the ink at shear rates between about 30 s⁻¹ to about 300 s⁻¹. Shear stress values (γ) are measured from the curve on the CARRI-MED rheometer (CSL² 500) at a range of shear rates (typically 0.3, 10, 30, 100, 500, and 1200 s⁻¹), and the measured shear stress values are fitted to the shear rates using a curve-fitting program. There are variations on both the Cross and Power law models as well as other models to describe the behavior of a non-Newtonian liquid, and these variations and other models can also be used to determine the shear-thinning index of an ink disclosed herein.

The marking compositions herein preferably have a shear-thinning index (n) from about 0.35 to about 1.0, or from about 0.5 to about 0.9, and more preferably from about 0.6 to about 0.8.

Suitable polymeric shear-thinning materials provide inks which are thickened viscous liquids at rest or at low shear rates. For example, the ink disclosed herein has a viscosity of at least 50 cP and advantageously about 100 cP or higher at a shear rate of 30 s⁻¹. However, in response to shear rates produced by writing (approximately 0.1 s⁻¹ to 500 s⁻¹), the inks undergo shear-thinning and have a viscosity of about 100 cP or less. Accordingly, suitable gelling agents or thickeners are those which, in combination with the other components described herein, can provide an ink having a shear-thinning index (n) between about 0.35 to about 1.0, a viscosity of at least 50 cP at a shear rate of 30 s⁻¹, and a viscosity of about 100 cP or less at shear rates produced by writing. The ink disclosed can include one or both of a gelling agent and thickener, and one or more of each variety of rheology modifier.

Suitable gelling agents include polysaccharides and derivatives thereof (e.g., METHOCEL cellulose available from Dow Chemical Co. of Midland, Mich.), starches and derivatives thereof (e.g., potato starch), hydrogels and derivatives thereof, silica gels and derivatives thereof, polyvinyl alcohol and derivatives thereof, and combinations of any of the foregoing. Preferred gelling agents include polysaccharides and more preferably xanthan gum. A gelling agent preferably is present in an amount in a range of about 0.1% to about 10% by weight based on the total weight of the composition, more preferably, about 0.1% to about 1% by weight.

Suitable thickeners include glycols such as polyethylene glycol, polyvinylpyrrolidone (PVP), copolymers of PVP, polyvinylacetate (PVA), copolymers of PVA, clays, talc, and other materials that are capable of increasing the viscosity of a composition, such as film-forming agents. To achieve an ink with the appropriate viscosity to achieve gel-like shear-thinning properties, a thickener is preferably added in a sufficient quantity to increase the viscosity of an ink to from about 5,000 cP to about 10,000 cP. As the viscosity of the ink becomes greater than about 10,000 cP, the ink shear thinning effect tends to lessen to such a degree that the application of shear force tends to have an insubstantial effect on the viscosity of the ink. Put another way, inks with a viscosity above about 10,000 cP tend to be less able to achieve the gel and gel-like property of shear thinning. The thickener preferably is selected from PVP and copolymers thereof, PVA and copolymers thereof, clays, talc, and combinations of the foregoing. More preferably, the thickener is selected from PVP, copolymers thereof, and combinations of the foregoing.

When the thickener or gelling agent used is a polymer (e.g., PVP), the thickener can be selected with a wide range of viscosities and molecular weights. For example, PVP is commercially available at various viscosities, and in a molecular weight range of 10,000 daltons to 1,300,000 daltons (Aldrich Chemical Co., Inc., Milwaukee, Wis.), for example. Thus, depending on the choice of viscosity and molecular weight of a polymer thickener, there can be a great deal of variation in the amount of thickener utilized in the ink. To achieve a viscosity at which the ink is shear-thinning, a thickener preferably reaches a viscosity between about 5,000 cP and about 10,000 cP. For example, when PVP with an average molecular weight of 130,000 daltons is used as a thickener, between about 3 wt. % and about 6 wt. % of PVP based on the total weight of the composition is sufficient to achieve a shear-thinning ink. A thickener used herein preferably is present in an amount in a range of about 3 wt. % to about 50 wt. % based on the total weight of the composition, more preferably about 5 wt. % to about 20 wt. %.

The marking compositions disclosed herein are water-based (aqueous). Water is used with the other components of the composition to provide a marking composition of a suitable viscosity for delivery by an applicator. In one embodiment, water is present in an amount of at least 20% by weight based on the weight of the composition, or greater than 20% by weight. For example, in one ink embodiment, water is preferably at least 20% by weight of the ink, and in certain embodiments contemplated for roller-ball applicator devices preferably is present in an amount at least 70% or 80% by weight, for example in a range of about 70% to about 95% by weight of the total weight of the ink, more preferably about 80% to about 90% by weight. In another embodiment, water is more than 50% by weight of the solvents used in the composition. The water acts to dissolve and/or suspend the various components and also provides the added benefit of improving washability various materials (e.g., clothes).

The eradicable nature of the ink is derived from the ability to convert the dye (chromophore) from a colored compound to at least substantially colorless, or alternatively, to another color (e.g., the color of the paper used). As discussed above, this can be achieved with the combination of a dye that is sensitive to oxidation. Dyes which are capable of performing this change in color include diarylmethane derivative dyes, triarylmethane derivative dyes, and methine derivative dyes. Diaryl dyes for use with the inks disclosed herein include Auramine O (Chemical Index No. 41000), and Basic Yellow 2 (Chemical Index No. 41000). In the colored state, the bi- and triarylmethane, and methine dyes often contain one or more cationic imine groups. The generic structure of a triarylmethane dye is shown below in formula (II):

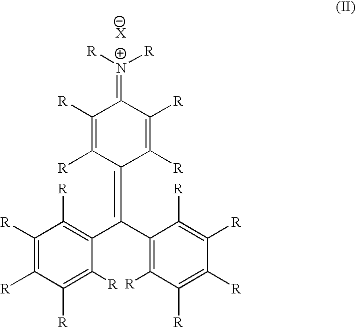

wherein each R group is the same or different and preferably is selected from C₁ to C₁₀ alkyl groups. A non-exhaustive list of triarylmethane dyes for use in inks disclosed herein are listed below in Table I.

TABLE I¹

| Color Index Name | Color Index No. | Common/Commercial Name |
|---|---|---|
| Acid Blue 22 | 42755 | Water Blue I |
| Acid Blue 93 | 42780 | Methyl Blue |
| Acid Fuchsin | 42685 | Acid Fuchsin |
| Acid Green | 42095 | Light Green Sf Yellowish |
| Acid Green 5 | 42095 | Light Green Sf Yellowish |
| Acid Magenta | 42685 | Acid Fuchsin |
| Acid Roseine | 42685 | Acid Fuchsin |
| Acid Rubin | 42685 | Acid Fuchsin |
| Acid Violet 17 | 42650 | Acid Violet 4BN |
| Acid Violet 19 | 42685 | Acid Fuchsin |
| Alizarol Cyanin R | 43820 | Eriochrome Cyanin R |
| Aluminon | 43810 | Triphenylmethane Chrome |
| | | Violet Cg |
| Aniline Blue Ws | | Aniline Blue Ws |
| Basic Blue 8 | 42563 | Victoria Blue 4r |
| Basic Blue 15 | 44085 | Night Blue |
| Basic Blue 20 | 42585 | Methyl Green |
| Basic Blue 26 | 44045 | Victoria Blue B |
| Basic Fuchsin | | Basic Fuchsin |
| Basic Green 4 | 42000 | Malachite Green |
| Basic Red 9 | 42500 | Pararosanilin |
| Basic Red 14 | 48016 | Cationic Brilliant Red 5GN |
| Basic Violet 2 | 42520 | New Fuchsin |
| Basic Violet 3 | 42555 | Crystal Violet |
| Basic Violet 4 | 42600 | Ethyl Violet |
| Basic Violet 14 | 42510 | Rosanilin |
| Chrome Violet Cg | 43810 | Triphenylmethane Chrome |
| | | Violet Cg |
| Chromoxane Cyanin R | 4382 | Eriochrome Cyanin R |
| Cotton Blue | 42780 | Methyl Blue |
| Crystal Violet | 42555 | Crystal Violet |
| Dahlia | 42530 | Hoffman's Violet |
| Diamond Green B | 42000 | Malachite Green |
| Eriochrome Cyanin R | 43820 | Eriochrome Cyanin R |
| Ethyl Green | 42590 | Ethyl Green |
| Ethyl Violet | 42600 | Ethyl Violet |
| Fast Green Fcf | 42053 | Fast Green Fcf |
| Food 3 | 42053 | Fast Green Fcf |
| Gentian Violet | | Methyl Violet 2b |
| Helvetia Blue | 42780 | Methyl Blue |
| Hoffman's Violet | 42530 | Hoffman's Violet |
| Light Green | 42095 | Light Green Sf Yellowish |
| Lissamine Green Sf | 42095 | Light Green Sf Yellowish |
| Magenta 0 | 42500 | Pararosanilin |
| Magenta I | 42510 | Rosanilin |
| Magenta Ii | | Magenta Ii |
| Magenta Iii | 42520 | New Fuchsin |
| Malachite Green | 42000 | Malachite Green |
| Methyl Blue | 42780 | Methyl Blue |
| Methyl Green | 42585 | Methyl Green |
| Methyl Violet | 42535 | Methyl Violet 2b |
| Methyl Violet 2b | 42535 | Methyl Violet 2b |
| Methyl Violet 10b | 42555 | Crystal Violet |
| Mordant Blue 3 | 43820 | Eriochrome Cyanin R |
| Mordant Violet 39 | 43810 | Triphenylmethane Chrome |
| | | Violet Cg |
| New Fuchsin | 4252 | New Fuchsin |
| Night Blue | 44085 | Night Blue |
| Pararosanilin | 42500 | Pararosanilin |
| Primula | 42530 | Hoffman's Violet |
| Rosanilin | 42510 | Rosanilin |
| Solochrome Cyanin R | 43820 | Eriochrome Cyanin R |
| Victoria Blue 4r | 42563 | Victoria Blue 4r |
| Victoria Blue B | 44045 | Victoria Blue B |
| Victoria Green B | 42000 | Malachite Green |
| Water Blue I | 42755 | Water Blue I |
| ¹See, R. D. Lillie, Conn's Biological Stains (8th ed., 1969), Williams and Wilkins Company, Baltimore, Maryland; Susan Budavari (Ed.), The Merck Index, (12th ed., 1996), Merck & Co., Whitehouse Station, N.J; see also, P. A. Lewis (Ed.), Pigment Handbook Vol. I, Properties and Economics, sections I(D)f(1) and I(D)g, John Wiley | | |
| # & Sons, (2^{nd} ed., 1988); H. Zollinger, Color Chemistry: Syntheses, Properties, and Applications of Organic Dyes And Pigments, Chapter 4, VCH Publishers (1987); D. R. Waring and G. Hallas (Eds.), The Chemistry and Application of Dyes, Chapter 2, Section IX, Plenum Press (1990); and M. Okawara, T. Kitao, T. Hirashima, and M. Matsuoka, | | |
| # Organic Colorants: A Handbook of Data of Selected Dyes for Electro-Optical Applications, Section VI, Elsevier (1988). | | |

Another type of dye that can be used in an ink are the methine class of dyes. The methine dyes generally relate to dyes that contain one or more methine group chromophores (—CH═), also called methylidyne or methine group. When the methine dye only contains one methine group the dye is sometimes referred to as a cyanine dye, with three methine groups the dye is sometime referred to as a carbocyanine dye, and with more than three methine groups the dye is often referred to as a polymethine dye. An example of a methine dye is Thiazole Orange: 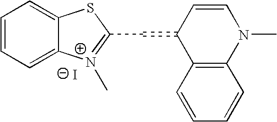
wherein the bonds that make up the methine group are shown above as broken lines. Other examples of methine dyes include Basic Red 15, Basic Yellow 11, and Basic Yellow 13. For a comprehensive listing of methine dyes, see F. M. Hamer, The Chemistry of Heterocyclic Compounds, A. Weissberger (Ed.), The Cyanine Dyes and Related Compounds, Wiley Interscience, New York (1964).

In spectroscopic terms, the color white is represented as having the property of reflecting light at of substantially all visible wavelengths without a substantial loss. If one considers the color white as a theoretical spectral starting point, once a wavelength of visible light is absorbed by the white material, that material is colored. Likewise, the color black, in spectroscopic terms, is represented as having the property of absorbing light at of substantially all visible wavelengths without a substantial loss.

When formulating an eradicable ink of a particular color, whether by the addition of one dye or a mixture of dyes, the rate of eradication of a dye (once applied to a substrate) is a consideration when selecting a dye. Without intending to be limited to a particular mechanism, it is believed that the rate of eradication of diarylmethane, triarylmethane, and methine dyes is proportional to the concentration of the dye in the ink. The compositions described herein include one or more dyes selected from the group consisting of diarylmethane dyes, triarylmethane dye, methine dyes, and combinations thereof. The dye preferably is present in an amount in a range of about 0.01% to about 10% by weight of the total weight of the composition, more preferably about 0.1% to about 6% by weight.

In selecting particular dyes for use, there are a number of dyes to choose from, and as a result, these dyes of different colors can be mixed to create an ink of almost any color. An eradicable ink disclosed herein can include two or more dyes that, when combined, provide an eradicable ink from a variety of colors. Preferably, the dyes are combined to provide a black eradicable ink. Two competing considerations when formulating a black eradicable ink are the rate of eradication and the intensity of the black color. An increase in the concentration of the dyes used to create the black color will increase the intensity of the color, however, as discussed above, an increase in the dye concentration also increases the amount of time needed to eradicate the dye. One preferred dye concentration for inks in the range of about 0.1% to about 6% by weight based on the total weight of the composition.

The color of the composition disclosed herein will primarily be determined by the dyes which cause the inks to absorb one or more wavelengths of visible light. Mixing two dyes to form an ink of a particular color can be done with the use of two complementary colors, or combinations that contain all three primary colors (red, yellow, and blue). When two complementary colors are mixed, the resultant mixture is gray, with black being the completely saturated form of gray. The complement color of red is green, the complement color of orange is blue, and the complement color of yellow is violet. When using complementary colors, these pairs of complementary colors actually reflect all three primary colors. For example, when red and green dyes are mixed as complementary colors, it is the equivalent of mixing red with yellow and blue, because green is composed of a mixture of the two primary colors yellow and blue. In another example, the mixture of the two complementary colors yellow and violet is the equivalent of mixing yellow with red and blue, because violet is composed of two primary colors, red and blue.

In the ink described herein, the color black can be achieved by the mixing of dyes of either two complementary colors (e.g., green-red, or yellow-magenta) or by dyes with the combination of all three primary colors (red, yellow, and blue). In the ink described herein, a black ink is preferably formed from the combination of a green dye with a dye selected from the group consisting of a red dye, a violet dye, and combinations thereof. A preferred combination of red and green is the combination of Basic Red 14 and Basic Green 4.

When combining two or more colors to form an ink of a desired color, it is understood that the desired color (e.g., black), may be reached even though an undertone of another color (e.g., a bluish-black color) might be perceptible. For example, it is understood that an ink that is colored black can have a red or a blue undertone, and yet still be considered a black ink.

When mixing dyes that are capable of eradication (e.g., di-, triarylmethane and methine dyes) into an ink, it is extremely difficult to prepare a black eradicable ink. Quite surprisingly, it has been found that the combination of a green eradicable dye and a violet and/or a red dye is able to mix to form a black eradicable ink. One embodiment of an ink disclosed herein is a black eradicable ink, including a mixture of two or more dyes selected from the group consisting of diarylmethane derivatives, triarylmethane derivatives, methine dyes, and combinations thereof, wherein the mixture of dyes appears black in color.

The black eradicable inks described herein are considered black even though they may have a red or blue undertone. Control of undertone of the black color can be achieved by altering the weight ratio of the red and green dyes used to mix to form the black color, for example. An increase in the red dye concentration will lead to a red undertone to the black ink, and an increase in the concentration of the green dye (a mixture of the two primary colors yellow and blue) will lead to a blue undertone. When a black ink is formed from the combination of a red dye and a green dye, the preferred weight ratio of the red dye to the green dye is in the range of about 10:1 about 1:10, more preferably about 4:1 to about 1:4. When a black ink is formed from the combination of a violet dye and a green dye, the preferred weight ratio of the violet dye to the green dye is in the range of about 10:1 about 1:10, more preferably about 4:1 to about 1:4.

A black eradicable ink can be formed by the combination of a green dye and a dye selected from the group consisting of red dyes, violet dyes, and combinations thereof. Preferably, the dye is formed from the combination of a green dye in an amount in a range of about 25% to about 98% by weight with a red dye in an amount in a range of about 2% to about 75% by weight, and/or with a violet dye in an amount in a range of about 2% to about 75% by weight, each based on the total weight of the dye portion of the ink. More preferably, the dye is formed from the combination a green dye in an amount in the range of about 25% to about 98% with a red dye present in an amount in the range of about 1% to about 30%, and/or with a violet dye present in an amount in the range of about 1% to about 30%, each by weight based on the total weight of the dye portion of the ink.

A green dye preferably is selected from the group consisting of Acid Green, Acid Green 5, Basic Green 4, Diamond Green B, Ethyl Green, Fast Green Fcf, Food Green 3, Light Green, Lissamine Green Sf, Malachite Green, Methyl Green, Victoria Green B, and combinations thereof. Preferably, a red dye is selected from the group consisting of Basic Red 9, Basic Red 14, Basic Red 15, Basic Red 29, Basic Red 46, and combinations thereof. Preferably, a violet dye is selected from the group consisting of Acid Violet 17, Acid Violet 19, Basic Violet 2, Basic Violet 3, Basic Violet 4, Basic Violet 14, Chrome Violet Cg, Crystal Violet, Ethyl Violet, Gentian Violet, Hoffman's Violet, Methyl Violet, Methyl Violet 2b, Methyl Violet 10b, Mordant Violet 39, and combinations thereof. To form a yellow ink, a yellow dye is preferably selected from the group consisting of Basic Yellow 11, Basic Yellow 13, Basic Yellow 21, Basic Yellow 28, Basic Yellow 29, Basic Yellow 40, and combinations thereof.

When an aqueous ink is used in a delivery system such as a ball-point pen or other writing instrument, is it preferred to use one or more slow-evaporating solvents to control the amount of time it takes for the ink to dry once it is applied to a substrate (drying time). As compared to water, slow-evaporating solvents will evaporate faster than water, and when an aqueous ink includes a slow-evaporating solvent, the drying time will decrease. In order to optimize and exercise control over the drying time of an ink, it may be necessary to include more than one slow-evaporating solvent. A slow-evaporating solvent preferably is an organic solvent which is substantially soluble in water. Preferably, the slow-evaporating solvent is selected from the group consisting of glycols, ureas, fatty alcohols, dimethylformamide, dimethylsulfoxide, high molecular weight hydrocarbons, and combinations thereof. More preferably, the slow-evaporating solvent is polyethylene glycol. The slow-evaporating solvent preferably is present in the ink in a range of about 5% to about 30% by weight based on the total weight of the composition, more preferably about 10% to about 20% by weight, to achieve a drying time suitable for typical writing instruments and marking applications.

Glycols for use as a slow-evaporating solvent, include, but are not limited to, three broad categories of glycols: (a) glycol ethers (e.g., ethylene glycol monomethyl ether, ethylene glycol monoethyl ether, ethylene glycol monobutyl ether, ethylene glycol monophenyl ether, diethylene glycol monomethyl ether, diethylene glycol monoethyl ether, diethylene glycol monoisopropyl ether, diethylene glycol monobutyl ether, diethylene glycol monophenyl ether, ethylene glycol dimethyl ether, ethylene glycol diethyl ether, diethylene glycol dimethyl ether, propylene glycol monomethyl ether); (b) glycol ether acetates such as ethylene glycol monomethyl ether acetate, ethylene glycol monoethyl ether acetate (e.g., ethylene glycol monobutyl ether acetate, ethylene glycol monophenyl ether acetate, diethylene glycol monomethyl ether acetate, diethylene glycol monoethyl ether acetate, diethylene glycol monobutyl ether acetate, diethylene glycol monophenyl ether acetate, diethylene glycol monoisopropyl ether acetate, ethylene glycol dimethyl ether acetate, ethylene glycol diethyl ether acetate, diethylene glycol dimethyl ether acetate, propylene glycol monomethyl ether acetate, and the like); and (c) glycol acetates (e.g., ethylene glycol monoacetate, ethylene glycol diacetate, and diethylene glycol diacetate). An ink composition can include other glycols not within one of these three categories, including glycols such as ethylene glycol, and ethoxylated glycols. A glycol may be used in the ink composition, preferably in an amount in the range of about 10% to about 20% by weight based on the total weight of the composition.

Fatty alcohols for use as a slow-evaporating solvent, include, but are not limited to, alcohols having eight through twenty carbon atoms, and fatty alcohols that are ethoxylated with one to three moles of ethylene oxide. Examples of fatty alcohols and ethoxylated fatty alcohols include, but are not limited to, behenyl alcohol, caprylic alcohol, cetyl alcohol, cetaryl alcohol, decyl alcohol, lauryl alcohol, isocetyl alcohol, myristyl alcohol, oleyl alcohol, stearyl alcohol, tallow alcohol, steareth-2, ceteth-1, cetearth-3, and laureth-2. Additional suitable fatty alcohols are listed in CTFA Cosmetic Ingredient Handbook, First ed., J. Nikotakis (Ed.), The Cosmetic, Toiletry and Fragrance Association, pages 28 and 45 (1988).

One embodiment of the ink includes water, a dye selected from the group consisting of diarylmethane derivatives, triarylmethane derivatives, methine dyes, and combinations thereof, and a slow-evaporating solvent, wherein the ink has a shear-thinning index in the range of about 0.35 to about 1.0.

A preferred eradicable marking composition will include a film-forming resin. In various embodiments, the film forming has one or more advantages including allowing easier (e.g., faster, more thorough, more efficient) eradication, reducing the time required until the substrate (e.g., paper) can be rewritten upon following eradication, and inhibiting or preventing reversal of eradication.

Without intending to be bound by any particular theory, it is believed that providing a film-forming resin in the mixture retains more of the ink on the surface of the substrate, especially porous substrates. A common porous substrate is paper, and will be referred to as the substrate in the following. Accordingly, film-forming resins that have high holdout characteristics are preferred. Film-forming resins that have low penetration into porous substrates, especially paper, are preferred. Without intending to be bound by any particular theory, it is believed that film-forming resins that are massive will provide better holdout on common substrates, possibly as a result of overall molecular chain length and consequent inter-chain entanglement. Without intending to be bound by any particular theory, it is also believed that hydrophobic resins will provide better holdout on common substrates, such as paper.

Holdout of a particular film-forming resin can often be indicated by the gloss of the resin resulting from solvent application and drying on a substrate. In addition or in the alternative, holdout may be gauged by examination of a cross-section of the dried resin on a substrate, for example by microscopic techniques such as electron microscopy.

According to the theory, by retaining more of the ink on the paper, the eradication is more easier and more efficient because the ink is more accessible to the eradicator. Thus, the eradicator contacts the ink before being absorbed by the paper, and the eradicator does not need to penetrate into the paper to reach and convert all of the ink chromophores. If the eradication is more efficient, less eradicator solution may be used, and rewriting over the eradicated portion can be performed sooner (e.g., less eradicator solvent is applied that must be evaporated).

The film-forming resin will typically have an effect on the rheology of the resulting composition, and can be used instead of, or in addition to the other rheology modifiers described herein. Different types and molecular weights of film-forming resins will have different holdout characteristics and effects on rheology. A film forming resin will preferably have a molecular weight of at least 1,000 daltons or greater, more preferably 5,000 daltons or greater, for example at least 10,000 daltons or greater than 10,000 daltons. The maximum molecular weight will depend n the concentration of film-forming resin used and the desired viscosity, and can be less than 5 million daltons, for example about 1 million daltons or less. Accordingly, a film-forming resin is preferably used in an amount of at least 0.01% by weight of the composition, and more preferably at least 0.1% by weight of the composition. A minimum concentration of 1% by weight is also contemplated. The film-forming resin preferably is present in an amount of 80% by weight or less, or 50% by weight or less, and more preferably 30% by weight or less.

Two characteristics of preferred resins are solubility in the aqueous composition used and holdout characteristics of the resulting film. A preferred film will be soluble at acidic pH, for example at a pH less than 7. Resins having solubility at pH 6 or less and at pH 5 or less are also contemplated.

Ionic and non-ionic film-forming resins are contemplated. In one embodiment, the resin is selected from resins which are soluble in the presence of acids. Examples include, but are not limited to, film-forming resins selected from the group consisting of primary amine containing polymers, secondary amine containing polymers, tertiary amine containing polymers, polyethylene-imines, polyamides-amines, polyamines and copolymers thereof.

Cationic resins can also be used. Examples include, but are not limited to, ammonium ions, tetra-substituted ammonium ions, sulfonium ions, phosphonium ions, and combinations thereof, for example poly(diallyldimethylammonium chloride).

Anionic polymeric resins that maintain solubility under acidic conditions can also be used. Such polymers include, but are not limited to, sodium alginate and chitosan; semi-synthesized high molecular weight materials such as ammonium alginate, and sodium polyalginate; synthetic high molecular weight materials such as sodium polyacrylate, copolymers of sodium acrylate and acrylamide, sodium polymethacrylate, acrylamide/acrylic acid copolymers, maleic anhydride/vinyl ether copolymers, styrene/sodium sulfonate copolymers, and other water-soluble acrylic resins.

Neutral resins are also contemplated, including, but not limited to, natural materials such as starches, mannans, glue plant, agar-agar, hibiscus, tragacanth rubber, gum arabic, dextran, levan, glue, gelatin casein, collagen; semi-synthetic high molecular weight materials such as methyl cellulose, ethyl cellulose, hydroxyethyl cellulose, carboxymethyl cellulose, carboxymethyl starch, etherified starches, cyanoated starches, and dialdehyde starches; and synthetic high molecular weight materials such as polyacrylamide and co-polymers thereof, polyvinyl alcohol and co-polymers thereof, polyethylene oxide and co-polymers thereof, polyvinyl pyrrolidone and co-polymers thereof, poly(2-vinylpyridine), poly(4-vinylpyridine), derivatives of the foregoing, and combinations of the foregoing.

Another preferred feature of the composition is the avoidance or omission of low surface tension organic solvents. Such solvents typically include ketones, esters, aldehydes, and phenols. An example is benzyl alcohol. Preferably, the composition is free of or substantially free of organic solvents having a surface tension less than about 35 dyne/cm², such as less than about 30 dyne/cm². In one embodiment, such solvents, if present, are 1% or less of the composition, preferably 0.1% or less of the composition.

Another aspect of the disclosure is a method of eradicating the composition including the step of applying an eradicator fluid to a marking made with an eradicable composition disclosed herein.

Another aspect of the disclosure is a kit that includes an eradicable composition described herein together with an eradicator fluid, for example for use in system of marking a substrate and eradicating the marking. Each of the ink and the eradicator fluid can be disposed in a writing instrument (e.g., a pen) for ease of use or it may be supplied in another form such as a dauber, a bottled free ink solution, a stamp pad, and the like. The kit includes an eradicable composition as described herein, and an eradicator as described herein.

After an eradicable ink described herein is applied to a substrate, the solvents present in the ink (e.g., water and the slow-evaporating solvent) will largely evaporate. Likewise, the solvents present in the eradicator fluid (e.g., water) will substantially or completely evaporate once the eradicator has been applied to the ink, leaving the oxidizing agent along with the ink components. Thus, another aspect of the invention is a resulting colorless or substantially colorless complex of the ink described herein with an eradicator fluid after the solvents have substantially or completely evaporated. The ink complex includes a colorless or substantially colorless dye selected from the group consisting of an oxidized diarylmethane derivatives, oxidized triarylmethane derivatives, oxidized methine dye, and combinations thereof, and at least one of a gelling agent and a thickener.

Another embodiment of the ink includes about 80% to about 90% water by weight based on the total weight of the composition, a dye including about 50% to about 98% of Basic Green 4, about 1% to about 30% of Basic Red 14, and about 1% to about 30% of Acid Violet 17, each by weight based on the total weight of the dye in the composition, about 0.1% to about 5% xanthan gum by weight based on the total weight of the composition, and about 10% to about 20% polyethyleneglycol by weight based on the total weight of the composition.

An ink is a mixture of components that impart different properties to the ink. For example, a surfactant may be used to affect the absorption of an ink by a substrate (e.g., paper), and a film-forming agent can also be used to improve the adhesion of the resulting mark to the substrate. Thus, the ink disclosed herein can include one or more additives selected from the group consisting of pH buffers, surfactants, biocides, anticorrosive agents, sequestering agents, and combinations thereof, in the amounts and proportions suitable for various applications.

### EXAMPLES

The following examples are not intended to limit the scope of the invention.

### Example 1

A black eradicable ink was prepared with the ingredients identified below in the amounts shown:

| Component | Function | Amount (wt. %) |
|---|---|---|
| Water | Solvent | 86.31 |
| Propylene Glycol | Slow-evaporating | 2.15 |
| | Solvent | |
| Glycerine | Slow-evaporating | 2.15 |
| | Solvent | |
| PE E-400 | Slow-evaporating | 2.15 |
| | Solvent | |
| Diethylene Glycol | Slow-evaporating | 2.15 |
| | Solvent | |
| DEHYDRAN 1513 | Surfactant | 0.2 |
| PLURONIC P104 | Surfactant | 0.98 |
| PROXEL GXL | Biocide | 0.29 |
| KELZAN AR | Gelling Agent | 0.68 |
| Basic Red 14 | Dye | 0.98 |
| Basic Green 4 | Dye | 1.96 |

The propylene glycol (available from EM Science of Gibbstown, N.J.), glycerine, polyethylene glycol (PE E-400, available from EM Science of Gibbstown, N.J.), diethylene glycol (available from ChemCentral of Chicago, Ill.), DEHYDRAN 1513 (available from Cognis of Cincinnati, Ohio), PLURONIC P104 (available from BASF, Mount Olive, N.J.), PROXEL GXL (available from Avecia, Inc. of Wilmington, Del.), and KELZAN AR (available from CP Kelco of Chicago, Ill.), were added at room temperature to the water and mixed until a homogenous, particulate-free solution was formed. The dyes were then added to this solution and the solution was mixed until the dyes were fully dissolved.

The resulting ink was then put into a PARKER 0.7 mm ball-point pen and applied to a sheet of white paper to determine the color of the ink once applied to a substrate. The ink was observed to be a black color with a blue undertone.

As described above, it is believed that the major contributing factor to the length of time it take to eradicate an ink is proportional to the weight percent of dye present in the ink. Thus, after the ink was applied to a white sheet of paper, the eradication time was tested with the commercially available eradicator solution available from Sanford Reynolds of Valence, France. The ink was eradicated (was not visible on the white paper) by completely covering the marking with eradicator solution and the marking was eradicated in approximately five seconds.

### Example 2

| Component | Function | Amount (wt. %) |
|---|---|---|
| Water | Solvent | 84.7 |
| Propylene Glycol | Slow-evaporating | 94 |
| | Solvent | |
| Polyvinylpyrrolidone | Thickener | 2.9 |
| Basic Red 14 | Dye | 0.8 |
| Basic Green 4 | Dye | 1.5 |
| Acid Violet 17 | Dye | 0.7 |

The propylene glycol (available from EM Science of Gibbstown, N.J.) and polyvinylpyrrolidone (K-90, available from ISP International of Wayne, N.J.) were added to the water and the resulting solution was mixed until the solution was homogeneous and particulate-free. The dyes where then sequentially added and the solution was mixed until there was no trace of undissolved dye in the solution.

The resulting ink was then put into a PARKER 0.7 mm ball-point pen and applied to a sheet of white paper to determine the color of the ink once applied to a substrate. The ink was observed to be a black color with a red undertone.

After the ink was applied to a white sheet of paper, the eradication time was tested with the commercially available eradicator solution (available from Sanford Reynolds of Valence, France). The ink was eradicated (was not visible on the white paper) by completely covering the marking with eradicator solution and the marking was eradicated in approximately five seconds.

### Example 3

| Component | Function | Amount (wt. %) |
|---|---|---|
| Water | Solvent | 51.20 |
| Glycerol | Slow-evaporating | 9.31 |
| | Solvent | |
| Polyvinyl Alcohol | Gelling agent | 2.13 |
| Acid Violet 19 | Dye | 5.72 |
| Acid Green 3 | Dye | 13.77 |
| Citric Acid | Acid | 0.7 |
| Phosphoric Acid (75% by | Acid | 3.04 |
| weight) | | |
| Dinonylphenol | Corrosion | 0.29 |
| | Inhibitor | |

The glycerol and polyvinyl alcohol were added to the water and the resulting solution was mixed until the solution was homogeneous and particulate-free. The dyes, acids, and corrosion inhibitor where then subsequently added and the solution was mixed until there was no trace of undissolved dye in the solution.

The resulting ink was then put into a PARKER 0.7 mm ball-point pen and applied to a sheet of white paper to determine the color of the ink once applied to a substrate. The ink was observed to be a black color with a green undertone.

After the ink was applied to a white sheet of paper, the eradication time was tested with the commercially available eradicator solution (available from Sanford Reynolds of Valence, France). The ink was eradicated (was not visible on the white paper) by completely covering the marking with eradicator solution and the marking was eradicated in approximately five seconds.

The foregoing description is given for clearness of understanding only, and no unnecessary limitations should be understood therefrom, as modifications within the scope of the invention may be apparent to those having ordinary skill in the art. Throughout the specification, where compositions are described as including components or materials, it is contemplated that the compositions can also consist essentially of, or consist of, any combination of the recited components or materials, unless stated otherwise.

1. A marking composition comprising a mixture of water, a dye selected from the group consisting of diarylmethane derivatives, triarylmethane derivatives, methine dyes, and combinations thereof, a slow-evaporating solvent, and a film-forming resin, wherein the composition is substantially free of organic solvents having a surface tension less than about 35 dyne/cm².

2. The composition of claim 1, wherein the mixture includes at least about 20% water based on the weight of the mixture.

3. The composition of claim 2, wherein the mixture includes at least about 70% water based on the weight of the mixture.

4. The composition of claim 1, wherein the mixture the film-forming resin has a molecular weight of at least about 1000 daltons.

5. The composition of claim 4, wherein the mixture the film-forming resin has a molecular weight of at least about 5,000 daltons.

6. The composition of claim 5, wherein the mixture the film-forming resin has a molecular weight of at least about 10,000 daltons.

7. The composition of claim 6, wherein the mixture the film-forming resin has a molecular weight greater than 10,000 daltons.

8. The composition of claim 1, wherein the mixture comprises about 0.01% by weight to about 80% by weight of the resin, based on the weight of the mixture.

9. The composition of claim 8, wherein the mixture comprises about 0.1% by weight to about 50% by weight of the resin, based on the weight of the mixture.

10. The composition of claim 9, wherein the mixture comprises about 0.1% by weight to about 30% by weight of the resin, based on the weight of the mixture.

11. The composition of claim 1, wherein the resin is soluble at acidic conditions.

12. The composition of claim 11, wherein the resin is ionic.

13. The composition of claim 12, wherein the resin is selected from the group consisting of ammonium ions, tetra-substituted ammonium ions, sulfonium ions, phosphonium ions, and combinations thereof.

14. The composition of claim 11, wherein the resin is selected from the group consisting of sodium alginate, chitosan, ammonium alginate, acrylates, sodium polyacrylates, copolymers of sodium acrylate and acrylamide, sodium polymethacrylate, acrylamide/acrylic acid copolymers, maleic anhydride/vinyl ether copolymers, styrene/sodium sulfonate copolymers, derivatives thereof, and combinations thereof.

15. The composition of claim 11, wherein the resin is selected from the group consisting of polyvinylpyrrolidone, copolymers of polyvinylpyrrolidone, poly(2-vinylpyridine), poly(4-vinylpyridine), derivatives thereof, and combinations thereof.

16. The composition of claim 11, wherein the resin is selected from the group consisting of starches, mannans, glue plant, agar-agar, hibiscus, tragacanth rubber, gum arabic, dextran, levan, glue, gelatin casein, collagen, methyl cellulose, ethyl cellulose, hydroxyethyl cellulose, carboxymethyl cellulose, carboxymethyl starches, etherified starches, cyanoated starches, and dialdehyde starches, polyacrylamide and co-polymers thereof, polyvinyl alcohol and co-polymers thereof, polyethylene oxide and co-polymers thereof, sodium polyalginate, and sodium polyacrylate, derivatives of the foregoing, and combinations of the foregoing.

17. The composition of claim 1, wherein the composition has a shear-thinning index in a range of about 0.35 to about 1.0

18. An eradicable ink kit comprising the composition of claim 1 and an eradicator fluid.

19. A marking composition comprising a mixture of at least about 20% by weight water based on the weight of the composition, a dye selected from the group consisting of diarylmethane derivatives, triarylmethane derivatives, methine dyes, and combinations thereof, a slow-evaporating solvent, and about 0.1% by weight to about 30% by weight of a film-forming resin having a molecular weight greater than 1,000 daltons based on the weight of the composition.

20. A marking composition comprising a mixture of at least about 70% by weight water based on the weight of the composition, a dye selected from the group consisting of diarylmethane derivatives, triarylmethane derivatives, methine dyes, and combinations thereof, a slow-evaporating solvent, and polyvinyl pyrrolidone in an amount in a range of about 3 wt. % to about 50 wt. % based on the total weight of the composition.
